(19) United States
(12) Patent Application Publication
(10) Pub. No.: US 2011/0222072 A1
(43) Pub. Date: Sep. 15, 2011

(54) APPARATUS AND METHOD FOR OPTICALLY MEASURING BY INTERFEROMETRY THE THICKNESS OF AN OBJECT

(76) Inventor: Leonardo Gwin Roberto Phillips, Due Carrare (PD) (IT)

(21) Appl. No.: 13/127,467

(22) PCT Filed: Nov. 4, 2009
(86) PCT No.: PCT/EP2009/064608

§ 371 Date: May 3, 2011

(30) Foreign Application Priority Data
Nov. 13, 2008 (IT) BO2008A000691

(51) Int. Cl. G01B 11/06

(52) U.S. Cl. 356/503

(57) ABSTRACT

Apparatus (1) and method for optically measuring by interferometry the thickness of an object (2) having an external surface (16) and an internal surface (17) opposite with respect to the external surface (16). There are included: a radiation source (4) which emits a low coherence beam of radiations (I) composed of a number of wavelengths within a determined band, and comprises at least two distinct emitters (20) emitting respective radiation beams that differ from one another and are concurrently activated; a spectrometer (5) analysing the spectrum of the result of the interference between radiations (R1) that are reflected by the external surface (16) without entering the object (2) and radiations (R2) that are reflected by the internal surface (17) entering the object (2); an optical probe (6) which is connected by means of optical fibers (8, 10, 11) to the radiation source (4) and to the spectrometer (5), and is arranged in such a way to face the slice (2) of semiconductor material to be measured for directing the beam of radiations (I) emitted by the radiation source (4) towards the external surface (16) of the object (2), and for collecting the radiations (R) reflected by the object (2); and a processing unit (18) calculating the thickness of the object (2) as a function of the spectrum provided by the spectrometer (5).

### TECHNICAL FIELD

The present invention relates to an apparatus and a method for optically measuring by interferometry the thickness of an object.

The present invention can be advantageously applied for optically measuring by interferometry the thickness of slices, or wafers, of semiconductor material (typically silicon), to which reference will be explicitly made in the specification without loss of generality.

### BACKGROUND ART

A slice of semiconductor material is machined, for example, to obtain integrated circuits or other electronic components in the semiconductor material. In particular, when the slice of semiconductor material is very thin, the slice of semiconductor material is placed on a support layer (typically made of plastic or glass) which provides a higher mechanical sturdiness, and thus an ease in handling. Generally, it is necessary to mechanically machine the slice of semiconductor material by grinding and polishing for obtaining a thickness which is regular and corresponds to a desired value. In the course of this mechanical machining phase of the slice of semiconductor material it is necessary to measure or keep under control the thickness for ensuring to obtain the desired value.

For measuring the thickness of a slice of semiconductor material it is known to employ gauging heads that have mechanical feelers touching an upper surface of the slice of semiconductor material being machined. This measuring technology may affect the slice of semiconductor material during the measuring operation owing to the mechanical contact with the mechanical feelers, and it doesn't enable to measure very thin thicknesses (typically smaller than 100 micron).

For measuring the thickness of a slice of semiconductor material it is known to use capacitive probes, inductive probes (of the eddy-current type or other types), or ultrasound probes. Since these measuring technologies are of the contactless type, they do not affect the slice of semiconductor material in the course of the measuring and can measure the thickness of the slice of semiconductor material even when there is the support layer. However, these measuring technologies are limited both in the dimensions that can be measured (typically thicknesses being smaller than 100 micron cannot be measured), and in the maximum resolution that can be achieved (typically not smaller than 10 micron).

Optical probes, in some cases associated with interferometric measures, are used for overcoming the limits of the above described measuring technologies. For instance, U.S. Pat. No. 6,437,868 and the published Japanese patent application JP-A-08-216016 describe apparatuses for optically measuring the thickness of a slice of semiconductor material. Some of the known apparatuses include an infrared radiation source, a spectrometer, and an optical probe, which is connected to the infrared radiation source and to the spectrometer by means of optical fibres, it is placed in such a way to face the slice of semiconductor material to be measured, and it carries lenses for focusing the radiations on the slice of semiconductor material to be measured. The infrared radiation source emits a beam of infrared radiations (generally having a wavelength of about 1300 nm), more specifically a low coherence beam which means that it is not monofrequency (single frequency being constant in time), but it is composed of a number of frequencies (typically having wavelengths variable in an interval of about 50 nm around the central value). Infrared radiations are employed since the currently used semiconductor materials are made of silicon which is sufficiently transparent to the infrared radiations. In some of the known apparatuses, the infrared radiation source is composed of a SLED (Superluminescent Light Emitting Device) which can emit a beam of infrared radiations having a bandwidth with an order of magnitude of about 50 nm around the central value.

However, even by using optical probes associated to interferometric measures of the above mentioned type, thicknesses being smaller than about 10 micron can not be measured, whereas the semiconductor industry is now requiring to measure thicknesses of few or very few micron.

### DISCLOSURE OF THE INVENTION

The purpose of the present invention is to provide an apparatus and a method for optically measuring by interferometry the thickness of an object which overcome the above described inconveniences, and can be concurrently easily and cheaply implemented.

The purpose is reached by an apparatus and a method for optically measuring by interferometry the thickness of an object according to what is claimed in the accompanying claims.

### BRIEF DESCRIPTION OF THE DRAWINGS

The present invention is now described with reference to the enclosed sheets of drawings, given by way of non limiting example, wherein:

FIG. 1 is a simplified view, with some parts removed for the sake of clarity, of an apparatus according to the present invention for optically measuring by interferometry the thickness of a slice of semiconductor material;

FIG. 2 is a simplified, cross-sectional, side view of the slice of semiconductor material while the thickness of which is measured;

FIG. 3 is a simplified view, with some parts removed for the sake of clarity, of an infrared radiation source of the apparatus of FIG. 1; and

FIG. 4 is a diagram showing a band composition carried out in the infrared radiation source of FIG. 3.

### BEST MODE FOR CARRYING OUT THE INVENTION

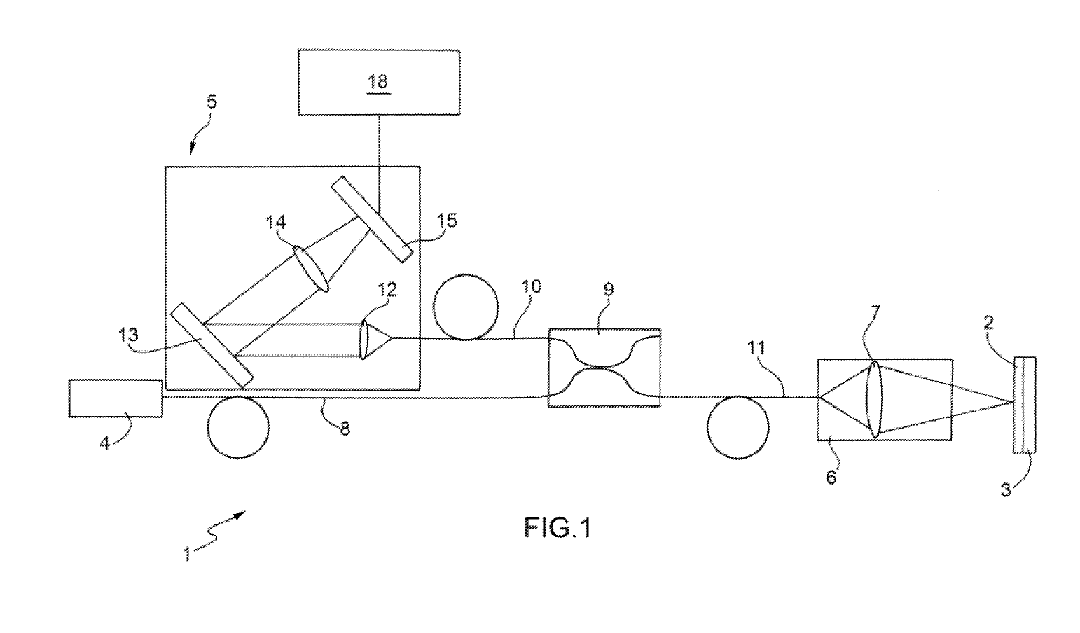

In FIG. 1, the reference number 1 indicates, on the whole, an apparatus for optically measuring by interferometry the thickness of an object 2 formed by a slice of semiconductor material.

According to the embodiment illustrated in FIG. 1 including per se known features, the slice 2 of semiconductor material is placed on a support layer 3 (typically made of plastic or glass) which serves to provide a higher mechanical sturdiness, and thus an ease in handling. According to a different embodiment, herein not illustrated, the support layer 3 is omitted.

The apparatus 1 includes an infrared radiation source 4, a spectrometer 5, and an optical probe 6 which is connected by means of optical fibers to the infrared radiation source 4 and to the spectrometer 5, it is arranged in such a way to face the slice 2 of semiconductor material to be measured, and it carries lenses 7 for focusing the radiations on the slice 2 of semiconductor material to be measured. Typically, the optical probe 6 is arranged in such a way to be perpendicular, as shown in FIG. 1, or slightly angled with respect to the slice 2 of semiconductor material to be measured, the optical probe 6 being set apart from the latter by air or liquid, through which the infrared radiations propagate.

According to the embodiment shown in FIG. 1, there is a first optical fiber 8 connecting the radiation source 4 to an optical coupler 9, a second optical fiber 10 connecting the optical coupler 9 to the spectrometer 5, and a third optical fiber 11 connecting the optical coupler 9 to the optical probe 6. The optical fibers, more specifically the first 8, second 10 and third 11 optical fibers can end up at a circulator, which is per se known and thus not illustrated in FIG. 1, or at another device serving as the coupler 9.

According to the embodiment illustrated in FIG. 1, the spectrometer 5 includes at least a lens 12 collimating the radiations received by the second optical fiber 10 on a diffractor 13 (typically composed of a grating), and at least a further lens 14 focusing the radiations reflected by the diffractor 13 on a radiation detector 15 (typically formed by an array of photosensitive elements, for example a “CCD” sensor).

The infrared radiation source 4 emits a low coherence beam of infrared radiations, which means that it is not monofrequency (a single frequency being constant in time), but it is composed of a number of frequencies.

Infrared radiations are employed, since the currently used semiconductor materials are made of silicon, and the silicon is sufficiently transparent to the infrared radiations.

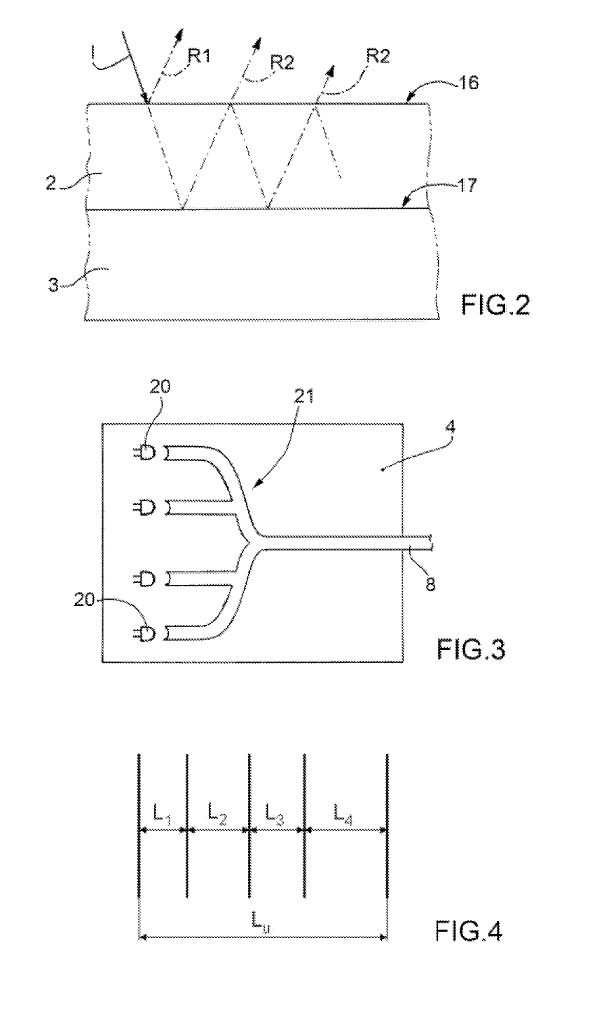

According to what is illustrated in FIG. 2 and is generally known, when used the optical probe 6 emits a beam of infrared radiations I which is directed onto the slice 2 of semiconductor material to be measured, and in part (reflected radiations R1) it is reflected towards the optical probe 6 by an external surface 16 without entering the slice 2 of semiconductor material, and in part (reflected radiations R2) it enters the slice 2 of semiconductor material and is reflected towards the optical probe 6 by an internal surface 17 opposite with respect to the external surface 16. It should be noted that, for the sake of understanding, in FIG. 2 the incident radiations I and the reflected radiations R are represented forming an angle which differs from a 90° angle with respect to the slice 2 of semiconductor material. In reality, as stated hereinbefore, these radiations can be perpendicular or substantially perpendicular to the slice 2 of semiconductor material.

The optical probe 6 catches both the radiations R1 that have been reflected by the external surface 16 without entering the slice 2 of semiconductor material, and the radiations R2 that have been reflected by the internal surface 17 entering the slice 2 of semiconductor material.

As shown in FIG. 2, the radiations R2, that have been reflected by the internal surface 17 entering the slice 2 of semiconductor material, can leave the slice 2 of semiconductor material after just one reflection on the internal surface 17, after two subsequent reflections on the internal surface 17, or more generally, after a number N of subsequent reflections on the internal surface 17. Obviously, upon each reflection a part of the radiation R2 leaves the slice 2 of semiconductor material through the external surface 16 until the residual intensity of the radiations R2 is almost null.

As previously stated, the beam of infrared radiations is composed of radiations having different frequencies (that is, having different wavelengths).

Among these radiations there is certainly a radiation the wavelength thereof is such that twice the thickness of the slice 2 of semiconductor material to be checked is equal to an integer multiple of the wavelength itself. As a consequence, this radiation that is reflected by the internal surface 17, leaves the slice 2 of semiconductor material in phase with the radiation of the same wavelength reflected by the external surface 16, and is added to the latter so determining a maximum of interference (constructive interference). On the contrary, a radiation which has a wavelength being such that twice the thickness of the slice 2 of semiconductor material to be checked is equal to an odd multiple of the half-wavelength, when reflected by the internal surface 17 leaves the slice 2 of semiconductor material in antiphase with the radiation of the same wavelength reflected by the external surface 16, and is added to the latter so determining a minimum of interference (destructive interference).

The result of the interference between reflected radiations R1 and R2 is caught by the optical probe 6 and is conveyed to the spectrometer 5. The spectrum which is detected by the spectrometer 5 for each frequency (that is, for each wavelength) has a different intensity determined by the alternation of constructive and destructive interferences.

A processing unit 18 receives the spectrum from the spectrometer 5 and analyses it by means of some mathematical operations, per se known. In particular, by performing Fourier analysis as a function of frequency and by knowing the refractive index of the semiconductor material, the processing unit 18 can determine the thickness of the slice 2 of semiconductor material by suitably processing the Fourier analysis of the spectrum provided by the spectrometer 5.

Going into more details, in the processing unit 18 the spectrum (as a function of the wavelength) is processed, in a per se known way, as a periodic function which can be mathematically expressed by a Fourier series. The interference of the reflected radiations R1 and R2 expands as a sinusoidal function (wherein there is an alternation of constructive and destructive interferences); the frequency of this sinusoidal function is proportional to the length of the optical path through the thickness of the slice 2 of semiconductor material through which the radiation passes. By applying a Fourier transform, the value of the optical path through the slice 2 of semiconductor material and thus the equivalent thickness of the slice 2 of semiconductor material (corresponding to half the optical path) are determined. The actual thickness of the slice 2 of semiconductor material can be easily obtained by dividing the equivalent thickness of the slice 2 of semiconductor material by the refractive index of the semiconductor material of the slice 2 (for example, for the silicon it is equal to about 3, 5).

According to the present invention, the infrared radiation source 4 can emit an infrared radiation beam having a bandwidth greater than 100 nm and preferably equal to about 200 nm around the central value. As the bandwidth of the infrared radiation beam emitted by the radiation source 4 is definitely greater (at least twice the amount) than the bandwidth used in the similar known apparatuses, the above described apparatus 1 can measure thicknesses of few micron, whereas the similar known apparatuses can not measure thicknesses being smaller than 10 micron. In fact, on the basis of theoretical considerations and experimental tests, it has been noted that by greatly increasing the bandwidth of the infrared radiation beam emitted by the radiation source 4 it is possible to considerably decrease the limit defined by the smallest measurable thickness.

A particular embodiment also provides for reducing the central value of the emission band of the radiation source 4. In particular, according to this embodiment the central value of the emission band of the radiation source 4 is comprised between 1100 nm and 1300 nm and it is typically of about 1200 nm whereas in the similar known apparatus it is typically of about 1300 nm.

The aim of such reduction of the central value of the emission band of the radiation source 4 is to decrease the smallest measurable thickness; in fact, it has been noted that by reducing the wavelength of the infrared radiations it is possible to measure smaller thicknesses. It is to be noted that the wavelength reduction of the infrared radiations cannot be too considerable since by reducing the wavelength, the transparency of the semiconductor material is reduced, too, and thus it is more difficult to perform a proper measurement.

In order that the bandwidth of the infrared radiation beam emitted by the radiation source 4 is so considerably increased, it is necessary to completely change the structure of the radiation source 4 that, in the known apparatuses, is typically composed of a SLED (Superluminescent Light Emitting Diode) which cannot have a bandwidth greater than 50-60 nm.

According to what is illustrated in FIG. 3, the radiation source 4 includes four distinct emitters 20 (in particular four SLEDs 20) emitting respective radiation beams that differ from one another and are concurrently activated. Moreover, the radiation source 4 includes an optical adder comprising optical fibers which ends into the first optical fiber 8 and enables to join in a single comprehensive radiation beam the four radiation beams emitted by the four SLEDs 20.

The optical adder 21 can be implemented, for example, by means of one or more per se known couplers or circulators in a way which is per se known and thus herein not illustrated in details. The radiation beam emitted by each SLED 20 has a wavelength band which is different from, and substantially complementary to, the wavelength bands of the radiation beams emitted by the other SLEDs 20 in such a way that the bandwidth L_{U} of the comprehensive radiation beam composed by the joint of the four radiation beams of the single SLEDs 20 has a bandwidth which is definitely greater than the bandwidth L_{1 . . . 4} of the radiation beam emitted by each SLED 20.

FIG. 4 shows, in a very schematic way and with the only purpose of simplifying the understanding, the composition diagram of the different bandwidths L_{1 . . . 4} emitted by each SLED 20. In principle the comprehensive bandwidth L_{U} is equal to the sum of the bandwidth L_{1 . . . 4} of the radiation beam emitted by each SLED 20. In practical experience there occur not negligible phenomena of overlap among radiations of adjacent bands; however, such phenomena do not prevent from obtaining a considerable widening of the comprehensive band.

As an example, in the embodiments illustrated in FIGS. 3 and 4 the radiation source 4 includes four SLEDs 20; obviously the number of the SLEDs 20 can be different (e.g. two, three or more than four) as depending on the features of the SLEDs 20 available in the market and as a function of the wanted comprehensive bandwidth L_{U}.

The example shown in FIG. 2 refers to the particular case of a single slice 2 of semiconductor material placed on a support layer 3. However, applications of an apparatus and a method according to the present invention are not limited to the dimensional checking of pieces of this type. In fact, such apparatuses and methods can also be employed, for example, for measuring the thickness of one or more slices 2 of semiconductor material and/or of layers made of other materials located inside a per se known multilayer structure.

The above described apparatus 1 has many advantages since it can be easily and cheaply implemented, and especially it enables to measure thicknesses that are definitely smaller than the ones measured by similar known apparatuses. It is important to note that by only modifying the radiation source 4 it is possible to implement the above described apparatus 1 employing an existing apparatus, thus involving reduced update complexity and costs.

1. An apparatus for optically measuring by interferometry the thickness of an object heaving an external surface and an internal surface opposite with respect to the external surface, the apparatus comprising:
a radiation source emitting a low coherence beam of radiations composed of a number of wavelengths within a determined band;
a spectrometer analyzing a spectrum of the result of the interference between radiations that are reflected by the external surface without entering the object and radiations that are reflected by the internal surface entering the object;
an optical probe which is connected by means of optical fibers to the radiation source and to the spectrometer, and is arranged in such a way to face the object to be measured for directing the beam of radiations emitted by the radiation source towards the external surface of the object, and for collecting the radiations that are reflected by both the external and the internal surfaces of the object; and
a processing unit that calculates the thickness of the object as a function of the spectrum analyzed by the spectrometer;
wherein the radiation source includes at least two distinct emitters emitting respective radiation beams that differ from one another and are concurrently activated.

2. The apparatus according to claim 1, wherein the radiation source includes an optical adder, which enables to join in a single comprehensive radiation beam the radiation beams emitted by the emitters in such a way that the radiation source emits a comprehensive radiation beam.

3. The apparatus according to claim 1, wherein the low coherence beam of radiations emitted by the radiation source has a bandwidth that is greater than 100 nm around a central value.

4. The apparatus according to claim 3, wherein said bandwidth is about 200 nm around the central value.

5. The apparatus according to claim 1, wherein the low coherence beam of radiations emitted by the radiation source has a bandwidth with a central value between 1100 nm and 1300 nm.

6. The apparatus according to claim 5, wherein the central value is about 1200 nm.

7. The apparatus according to claim 1, wherein the radiation beam emitted by each emitter has its own wavelength band which is different from, and substantially complementary to, the wavelength bands of the radiation beams emitted by the other emitters.

8. The apparatus according to claim 1, wherein the radiation source includes at least four emitters.

9. The apparatus according to claim 1, wherein each emitter includes a SLED.

10. The apparatus according to claim 1, wherein the object is a slice of semiconductor material.

11. The apparatus according to claim 10, wherein the object is a silicon slice.

12. A method for optically measuring by interferometry the thickness of an object having an external surface and an internal surface opposite with respect to the external surface, the method including the steps of:
emitting a low coherence beam of radiations composed of a number of wavelengths within a determined band by means of a radiation source with at least two distinct emitters;
directing the beam of radiations onto the external surface of the object by means of an optical probe;
collecting radiations that are reflected by the object by means of the optical probe;
analyzing by means of a spectrometer a spectrum of the result of the interference between radiations that are reflected by the external surface without entering the object and radiations that are reflected by the internal surface entering the object; and
determining the thickness of the object as a function of the spectrum analyzed by the spectrometer;
wherein the method includes the further steps of:
concurrently activating said at least two distinct emitters of the radiation source that emit respective radiation beams differing from one another; and
joining the radiation beams emitted by the emitters to generate said low coherence beam of radiations as a comprehensive radiation beam.
